(19) United States
(12) Patent Application Publication
(10) Pub. No.: US 2023/0344559 A1
(43) Pub. Date: Oct. 26, 2023

(54) TRANSMITTING FEEDBACK FOR REPETITIVE HARQ PROCESSES

(71) Applicant: QUALCOMM Incorporated, San Diego, CA (US)

(72) Inventors: Konstantinos DIMOU, New York, NY (US); Peter GAAL, San Diego, CA (US); Yi HUANG, San Diego, CA (US); Yan ZHOU, San Diego, CA (US); Tao LUO, San Diego, CA (US)

(21) Appl. No.: 18/306,225

(22) Filed: Apr. 24, 2023

Related U.S. Application Data
(60) Provisional application No. 63/363,571, filed on Apr. 25, 2022.

(51) Int. Cl. H04L 1/1812

(52) U.S. Cl. CPC H04L 1/1812

(57) ABSTRACT

Example implementations include a method, apparatus and computer-readable medium of wireless communication, comprising receiving a request for a first type of hybrid automatic repeat request (HARQ) codebook and a second type of HARQ codebook. The implementations further include identifying one or more HARQ processes in the first type of HARQ codebook that are repetitive in the second type of HARQ codebook. Additionally, the implementations further include transmitting corresponding feedback of the one or more repetitive HARQ processes only once to a network entity.

### CLAIM OF PRIORITY

### Technical Field

The present Application for Patent claims priority to U.S. Provisional Application No. 63/363,571 entitled “REMOVING AND/OR REPLACING REPETITIVE HARQ PROCESSES IN A MULTIPLEXED HARQ CODEBOOK” filed on Apr. 25, 2022, and assigned to the assignee hereof and hereby expressly incorporated by reference.

### BACKGROUND

### Technical Field

The present disclosure generally relates to communication systems, and more particularly, to hybrid automatic repeat request (HARQ) codebooks.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communication, comprising receiving a request for a first type of hybrid automatic repeat request (HARQ) codebook and a second type of HARQ codebook. The method further includes identifying one or more HARQ processes in the first type of HARQ codebook that are repetitive in the second type of HARQ codebook. Additionally, the method further includes transmitting corresponding feedback of the one or more repetitive HARQ processes only once to a network entity.

Another example aspect includes an apparatus for wireless communication, comprising a memory and a processor communicatively coupled with the memory. The processor is configured to receive a request for a first type of hybrid automatic repeat request (HARQ) codebook and a second type of HARQ codebook. The processor is further configured to identify one or more HARQ processes in the first type of HARQ codebook that are repetitive in the second type of HARQ codebook. The processor is further configured to transmit corresponding feedback of the one or more repetitive HARQ processes only once to a network entity.

Another example aspect includes an apparatus for wireless communication, comprising means for receiving a request for a first type of hybrid automatic repeat request (HARQ) codebook and a second type of HARQ codebook. The apparatus further includes means for identifying one or more HARQ processes in the first type of HARQ codebook that are repetitive in the second type of HARQ codebook. Additionally, the apparatus further includes means for transmitting corresponding feedback of the one or more repetitive HARQ processes only once to a network entity.

Another example aspect includes a computer-readable medium comprising stored instructions for wireless communication, executable by a processor to receive a request for a first type of hybrid automatic repeat request (HARQ) codebook and a second type of HARQ codebook. The instructions are further executable to identify one or more HARQ processes in the first type of HARQ codebook that are repetitive in the second type of HARQ codebook. Additionally, the instructions are further executable to transmit corresponding feedback of the one or more repetitive HARQ processes only once to a network entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network, in accordance with various aspects of the present disclosure.

FIG. 1B is a diagram illustrating an example of disaggregated base station (BS) architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 illustrates an example of transmitting feedback for repetitive HARQ processes only once, in accordance with various aspects of the present disclosure.

FIG. 5 is a flowchart of a method of wireless communication, in accordance with various aspects of the present disclosure.

FIG. 6 is a flowchart of a method of wireless communication, in accordance with various aspects of the present disclosure.

FIG. 7 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

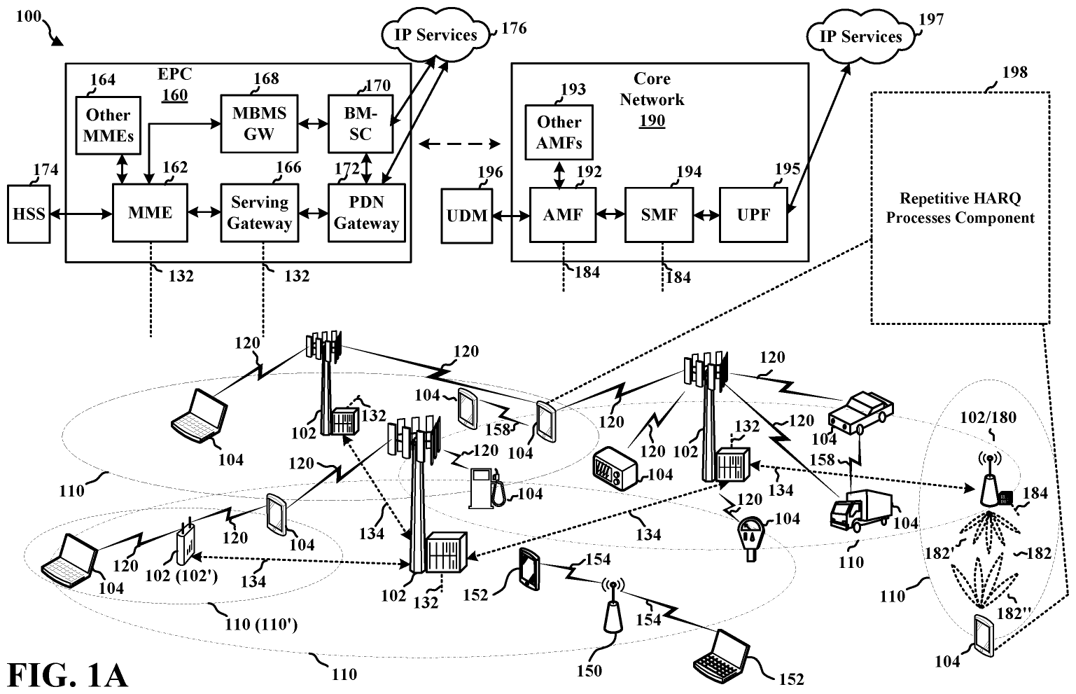

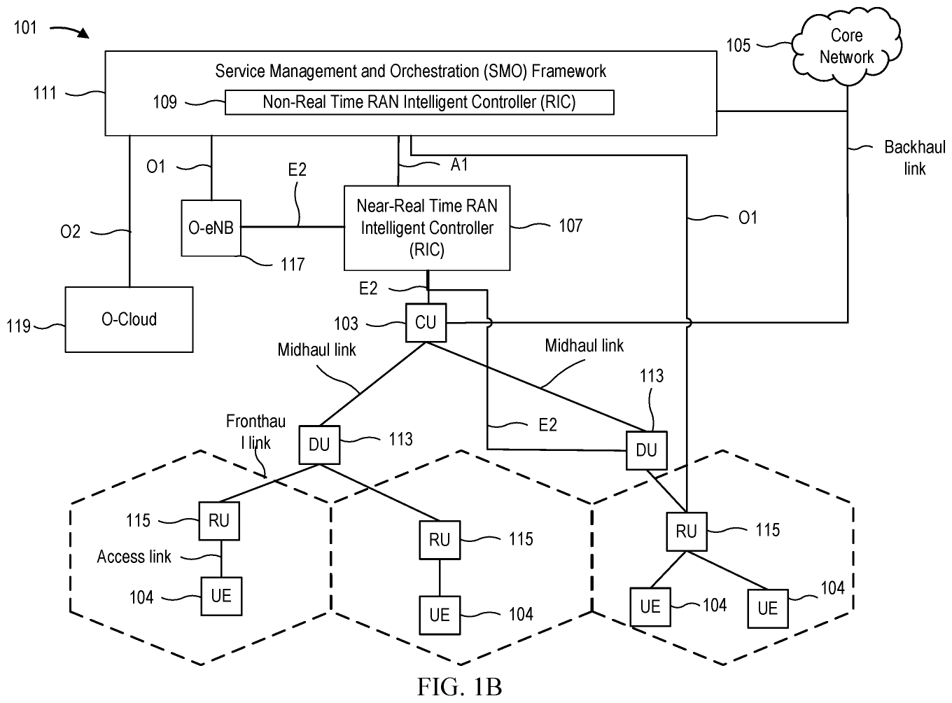

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1A, in certain aspects, one or more of the UE 104 may include a repetitive HARQ processes component 198, which may be configured to receive a request for a first type of hybrid automatic repeat request (HARQ) codebook and a second type of HARQ codebook; identify one or more HARQ processes in the first type of HARQ codebook that are repetitive in the second type of HARQ codebook; and transmit corresponding feedback of the one or more repetitive HARQ processes only once to a network entity. In some implementations, the repetitive HARQ processes component 198 may be configured to generate the second type of HARQ codebook and the first type of HARQ codebook in response to the request; multiplex the first type of HARQ codebook with second type of HARQ codebook to form a multiplexed HARQ codebook; modify the multiplexed HARQ codebook to form a modified multiplexed HARQ codebook; and transmit the modified multiplexed HARQ codebook to the network entity, where the corresponding feedback of the one or more HARQ processes are indicated only once in the multiplexed HARQ codebook. In some implementations, the repetitive HARQ processes component 198 may be configured to transmit the first type of HARQ codebook to the network entity, where the corresponding feedback of the one or more repetitive HARQ processes are indicated in the first type of HARQ codebook. In some implementations, the repetitive HARQ processes component 198 may be configured to refrain from transmitting the second type of HARQ codebook.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUs 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit—User Plane (CU-UP)), control plane functionality (i.e., Central Unit—Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

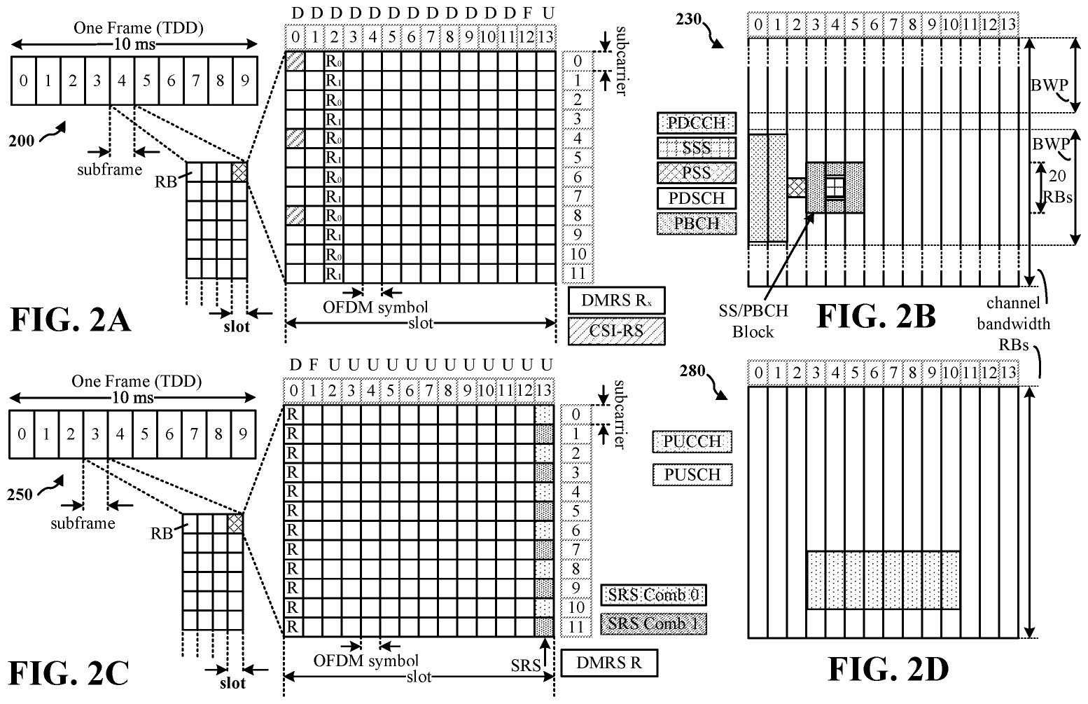

Referring to FIGS. 2A-2D, the UE 104 and/or base stations 102/180 may use one or more of the frame structures, channels, and/or resources of diagrams 200, 230, 250 and/or 280 for communications with one another. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

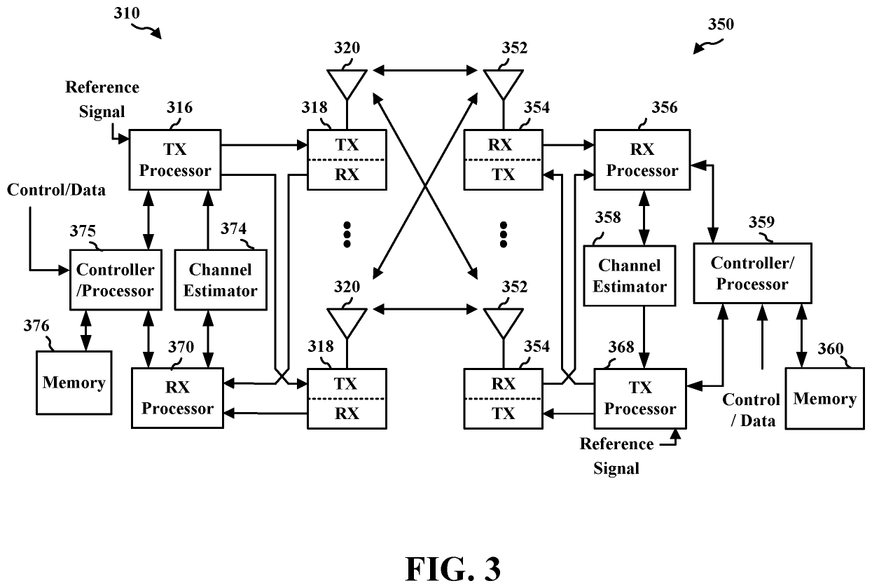

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with repetitive HARQ processes component 198 of FIG. 1A.

In the context of some RANs, a codebook may be a set of values (e.g., a matrix, such as a matrix having complex number elements) that may be used to map bits to antenna ports. For downlink/uplink communications between a network entity (e.g., BS 102/180) and UE 104, one or more codebooks (e.g., semi-static codebook, dynamic codebook, and the like) are provided where each downlink control information (DCI) transmission from the network entity (e.g., BS 102/180) can include multiple parameters for group feedback. For example, the DCI can include a value of group (g=0 or g=1) for the scheduled physical downlink shared channel (PDSCH), and counter (C)-downlink assignment index (DAI) and/or total (T)-DAI are accumulated within each PDSCH group. For example, the DCI can include NFI for the scheduled PDSCH group that operates as a toggle bit, such that when NFI is toggled, DAI for the group can be reset (A/N for a PDSCHs in a group before the reset are not transmitted; after the reset, the A/N for previous groups is considered). For example, the DCI can include a bit to indicate whether the feedback for the other group (non-scheduled group) is also requested or not. The following fields can be present in the DCI based on radio resource control (RRC) configuration (e.g., the fields can be present or absent), and can provide extra reliability in case of missing DCIs: NFI for the other group (non-scheduled group), total DAI for the other group (non-scheduled group), hybrid automatic repeat/request (HARQ)-Ack codebook, etc. For example, the total DAI for the other group may be separate from regular C-DAI (for the scheduled group) and regular T-DAI (for the scheduled group), which is present when UE 104 is configured more than one downlink (DL) component carrier (CC). The HARQ-Ack codebook can be generated separately for each PDSCH group to yield first/second HARQ-Ack information. The values of NFI/T-DAI for the other group (if present) can be used to correct codebook size in case of one or more last DCIs for a given group are missed. The value of request field can be used so that UE 104 knows the feedback for the other group should be included or not.

A UE 104 can be configured for different types of the codebooks. For example, a UE 104 can be configured with a semi-static codebook, such as a Type 1 HARQ codebook. For a Type 1 HARQ codebook, a UE 104 may be configured to transmit feedback for every n time duration (e.g., n number of slots). The size of a Type 1 HARQ codebook is fixed, and the UE 104 transmits feedback for each of the n number of slots even if the UE 104 does not receive any transmission (e.g., a PDSCH transmission) in a slot. For example, in Type 1 HARQ codebook, a UE 104 may transmit a NACK feedback for the slots in which it does not receive any transmission (e.g., a PDSCH transmission). Similarly, a UE 104 can be configured with a dynamic HARQ codebook, such as a Type 2 HARQ codebook. In a Type 2 HARQ codebook, a UE 104 can transmit feedback for only the slots in which it receives a PDSCH transmission. The size of a Type 2 HARQ codebook is not fixed. For a Type 2 HARQ codebook, as described above, a network entity (e.g., BS 102/180) can indicate to the UE 104 a DAI, and based on the DAI, a UE 104 may determine whether it should have received a transmission, and if the UE 104 determines that based on the DAI, the UE 104 should have received a transmission, but did not, the can transmit a negative feedback (e.g., a NACK) in the codebook for that transmission. For example, the UE 104 can map a NACK in a location in the codebook corresponding to that PDSCH transmission, and transmit that codebook to the network entity (e.g., BS 102/180).

A UE 104 can be configured for a Type 3 HARQ codebook, where the UE 104 transmits feedback for the HARQ processes that are active. In some implementations, a network entity (e.g., BS 102/180) may configure the UE 104 (e.g., via RRC configuration) to transmit feedback for a set of HARQ processes, and the UE 104 can transmit a Type 3 HARQ codebook with feedback for those set of HARQ processes. The network entity (e.g., BS 102/180) may configure (e.g., via RRC) a UE 104 with one or more Type 3 HARQ codebooks (e.g., 8 Type 3 HARQ codebooks) simultaneously, and the network entity (e.g., BS 102/180) may request (e.g., via DCI) transmission of one or more of the configured Type 3 HARQ codebooks from the UE 104. For example, the network entity (e.g., BS 102/180) may identify a set of HARQ processes as high priority HARQ processes, and configure the UE 104 for a Type 3 HARQ codebook that includes feedback for the set of HARQ processes. The network entity (e.g., BS 102/180) may transmit a request (e.g., via DCI) to the UE 104 for the corresponding Type 3 HARQ codebook for the identified set of HARQ processes. The network entity (e.g., BS 102/180) may transmit the request for a Type 3 HARQ codebook or a non-Type 3 HARQ codebook when the network entity (e.g., BS 102/180) does not receive or is unable to decode feedback for a HARQ process included in the set of HARQ processes for which the Type 3 HARQ codebook or a non-Type 3 HARQ codebook is configured. The network entity (e.g., BS 102/180) may request for the Type 3 HARQ codebook and the non-Type 3 HARQ codebook in the same slot.

The UE may transmit that Type 3 HARQ codebook. However, to improve performance, a UE may multiplex the requested Type 3 HARQ codebook with another HARQ codebook (e.g., a Type 1 or Type 2 HARQ codebook) of a different priority onto a same control channel (e.g., PUCCH, PUSCH, and the like) and the transmit the multiplexed HARQ codebook. However, sometimes, one or more HARQ processes included in the Type 3 HARQ codebook may also be included in the other type of HARQ codebooks or HARQ codebooks with which the Type 3 HARQ codebook may be multiplexed. Thus, it may result in the UE transmitting feedback for one or more of such repetitive or duplicated HARQ processes multiple times, and/or such repetitive or duplicated HARQ processes may appear two or more times in the multiplexed HARQ codebook, which can significantly increase the overhead in communications from the UE to the network entity (e.g., BS 102/180), and may reduce performance of the UE.

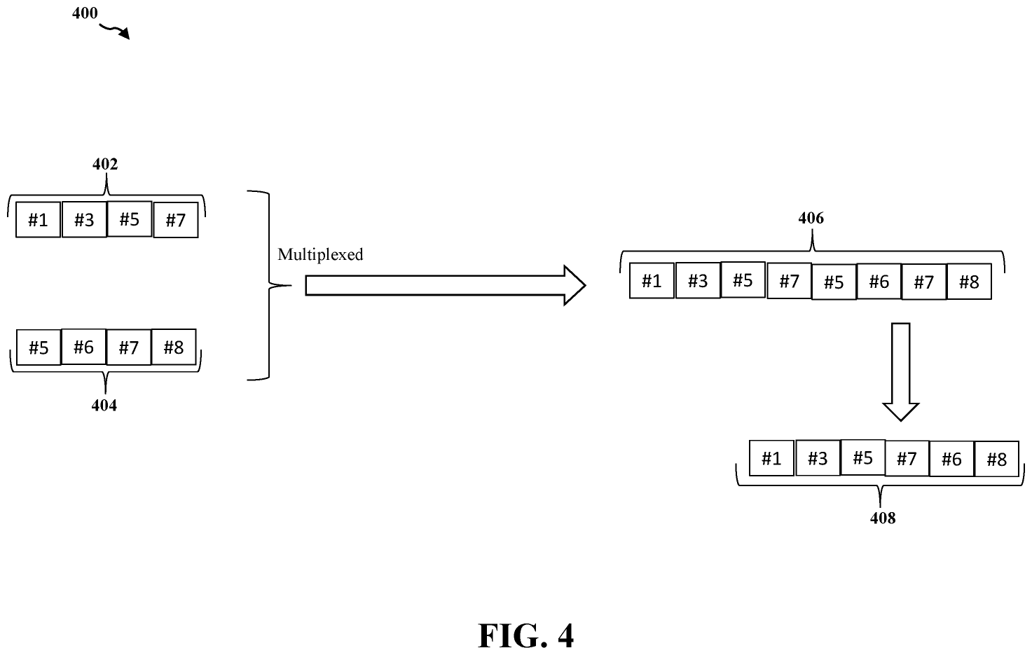

Aspects described herein relate to techniques for transmitting feedback for repetitive HARQ processes only once. Additional details of transmitting feedback for repetitive HARQ processes only once are described herein with respect to at least FIGS. 4-7.

FIG. 4 illustrates an example of transmitting feedback for repetitive HARQ processes only once. In FIG. 4, a UE 104 may be configured with a Type 3 HARQ codebook 402. As described above, the network entity (e.g., BS 102/180) may configure the UE 104 (e.g., via RRC) for a set of HARQ processes (e.g., a set of HARQ process IDs). For example, as shown in FIG. 4, the UE 104 may be configured with a Type 3 HARQ codebook 402 for HARQ processes 1, 3, 5, and 7. In some implementations, the UE 104 may receive a message (e.g., RRC message) configuring the Type 3 HARQ codebook 402, where the message indicates the set of HARQ process identifiers for the HARQ processes 1, 3, 5, and 7. The network entity may configure the UE 104 with one or more non-Type 3 HARQ codebooks (e.g., Type 1 or Type 2 HARQ codebook) for one or more of the same HARQ processes with which the Type 3 HARQ codebook is configured. For example, the UE 104 may be configured with a Type 1 or Type 2 HARQ codebook for HARQ processes 5 and 7, or 1 and 3, or 1 and 5, or 1 and 7, or 3 and 5, or 3 and 7, or any other such combination. If the network entity (e.g., BS 102/180) did not receive feedback or is unable to decode feedback for any of the HARQ processes included in the Type 3 HARQ codebook or the non-Type 3 HARQ codebook, then the network entity (e.g., BS 102/180) may transmit a request (e.g., via DCI) for the configured Type 3 HARQ codebook 402 and/or the configured non-Type 3 HARQ codebook. In some implementations, the network entity (e.g., BS 102/180) may request for the Type 3 HARQ codebook and/or the non-Type 3 HARQ codebook in the same slot.

The UE 104, in response to the request from the network entity, may be configured to transmit the feedback for any of the HARQ processes that are included in both the Type 3 and the non-Type 3 HARQ codebooks only once. In some implementations, the UE 104 may be configured to determine whether every HARQ process for which the non-Type 3 HARQ codebook is configured is included in the Type 3 HARQ codebook. The UE 104 may determine that every HARQ process for which the non-Type 3 HARQ codebook is configured is included in the Type 3 HARQ codebook by identifying

In some implementations, the UE 104 may be configured to transmit feedback for any of the HARQ processes only once by transmitting the Type 3 HARQ codebook and by refraining to transmit the non-Type 3 HARQ codebook. For example, if the UE 104 received a request to transmit the Type 3 HARQ codebook and a Type 2 HARQ codebook, where the Type 3 HARQ codebook 402 is configured for HARQ processes 1, 3, 5, and 7, and the Type 2 HARQ codebook, is configured for HARQ processes 5 and 7, then the UE 104 may transmit the Type 3 HARQ codebook 402 to the network entity and refrain from transmitting the Type 2 HARQ codebook. In some implementations, the UE 104 may be configured to transmit the Type 3 HARQ codebook and refrain from transmitting the non-Type 3 HARQ codebook based on determining that every HARQ process for which the non-Type 3 HARQ codebook is configured is included in the Type 3 HARQ codebook. Continuing with the above example, the UE 104 may transmit the Type 3 HARQ codebook and refrain from transmitting the Type 2 HARQ codebook based on determining that the HARQ processes with which the Type 2 HARQ codebook is configured, HARQ processes 5 and 7, are included in the Type 3 HARQ codebook. The UE 104 may determine whether HARQ processes with which the non-Type 3 HARQ codebook is configured are also included in the Type 3 HARQ codebook based on identifying the corresponding HARQ process identifiers in both Type 3 and non-Type 3 HARQ codebooks and/or configurations of the Type 3 and non-Type 3 HARQ codebooks. In some implementations, the UE 104 may generate the Type 3 HARQ codebook 402 based on its configuration, and transmit the generated Type 3 HARQ codebook 402 in response to the request. For example, the UE 104 may generate the Type 3 HARQ codebook 402 to include feedback for the HARQ processes 1, 3, 5, and 7.

In some implementations, the UE 104 may determine that every HARQ process for which the non-Type 3 HARQ codebook is configured is not included in the Type 3 HARQ codebook 402. For example, as shown in FIG. 4, the UE 104 may determine that the non-Type 3 HARQ codebook, such as Type 2 HARQ codebook 404, may be configured for one or more HARQ processes, such as HARQ processes 6 and 8, that are not included in the Type 3 HARQ codebook 402. The UE 104, in response to the request for the Type 3 HARQ codebook 402, may be configured to generate a non-Type 3 HARQ codebook (e.g., a Type 1 or Type 2 HARQ codebook) and the Type 3 HARQ codebook 402. For example, the UE 104 may be configured to provide feedback via a Type 1 HARQ codebook, and the UE 104, in response to receiving the request for the Type 3 HARQ codebook, may generate a Type 1 HARQ codebook and the Type 3 HARQ codebook. Similarly, the UE 104 may be configured to transmit feedback via a Type 2 HARQ codebook, and the UE 104, in response to receiving the request for the Type 3 HARQ codebook, may be configured to generate a Type 2 HARQ codebook and the Type 3 HARQ codebook. In some implementations, the UE 104 may be configured to generate a non-Type 3 HARQ codebook (e.g., a Type 1 or a Type 2 HARQ codebook) first and then generate the Type 3 HARQ codebook.

As an example, in FIG. 4, the UE 104 is configured to transmit feedback via a Type 2 HARQ codebook. Therefore, in FIG. 4, the UE 104 generates a Type 2 HARQ codebook 404 and the Type 3 HARQ codebook 402. The UE 104 may multiplex (e.g., intra-UE multiplexing) the Type 3 HARQ codebook 402 with the Type 2 HARQ codebook 404, resulting in a multiplexed HARQ codebook, such as the multiplexed HARQ codebook 406. As shown in FIG. 4, the multiplexed HARQ codebook 406 includes the HARQ processes (e.g., HARQ process IDs) and/or the feedback for the HARQ processes included in the Type 3 HARQ codebook 402, and the HARQ processes (e.g., HARQ process IDs) and/or the feedback for the HARQ processes included the Type 2 HARQ process codebook.

The UE 104 may determine whether the multiplexed HARQ codebook 406 includes any repetitive or duplicated HARQ processes. The UE 104 may identify repetitive or duplicated HARQ processes in the multiplexed HARQ codebook based on the HARQ processes included in the Type 3 HARQ codebook 402. For example, the UE 104 may check if a process ID included in the Type 3 HARQ codebook 402 is present in a portion of the multiplexed HARQ codebook 406 corresponding to the non-Type 3 HARQ codebook (e.g., Type 2 HARQ codebook 404). The UE 104 may be configured to modify the multiplexed HARQ codebook 406, resulting in a modified multiplexed HARQ codebook 408, when the UE 104 identifies presence of any repetitive HARQ processes in the multiplexed HARQ codebook 406. The UE 104 transmits the modified HARQ codebook 408 to the network entity (e.g., BS 102/180).

In some implementations, the UE 104 may modify the multiplexed HARQ codebook by removing the repetitive or duplicated HARQ processes. For example, in FIG. 4, the Type 3 HARQ codebook includes HARQ processes 1, 3, 5, and 7, and the generated Type 2 HARQ codebook 404 includes processes 5, 6, 7, and 8. As shown in the multiplexed HARQ codebook 406, the HARQ processes of 5 and 7 are repeated in the Type 2 HARQ codebook 404 portion of the multiplexed HARQ codebook 406. The UE 104 may modify the multiplexed HARQ codebook 406 by removing the HARQ processes 5 and 7 from the multiplexed HARQ codebook 406, resulting in the modified multiplexed HARQ codebook 408 with the HARQ processes 5 and 7 removed from the Type 2 HARQ codebook 404 portion of the multiplexed HARQ codebook 406. The UE 104 may be configured to transmit the modified multiplexed HARQ codebook 408 to the network entity (e.g., BS 102/180).

In some implementations, the size of the modified multiplexed HARQ codebook, such as the modified multiplexed HARQ codebook 408, may be smaller than the size of the multiplexed HARQ codebook 406, as shown in FIG. 4. If the UE 104 multiplexes a Type 3 HARQ codebook with a Type 2 HARQ codebook, as shown in in FIG. 4, and the UE 104 identifies repetitive or duplicated HARQ processes, then UE 104 may adjust the counter DAI and the total DAI by a number of repetitive or duplicated HARQ processes that are removed from the multiplexed HARQ codebook. For example, in FIG. 4, the UE 104 may reduce the counter DAI and the total DAI by 2 since two HARQ processes, 5 and 7, are removed from the Type 2 HARQ codebook portion of the multiplexed HARQ codebook. The UE 104 may transmit the updated counter DAI and the total DAI to the network entity (e.g., BS 102/180).

In some implementations, the UE 104 may not update the counter DAI and/or the total DAI to reflect the number of duplicate HARQ processes that are removed from the Type 2 HARQ codebook. The network entity (e.g., BS 102/180), based on the set of HARQ processes for which the Type 3 HARQ codebook 406 is configured, may determine the HARQ processes that have been removed from the Type 2 HARQ codebook portion of the HARQ codebook received from the UE 104. For example, since the network entity (e.g., BS 102/180) indicates to the UE 104 the set of HARQ processes to be included in the Type 3 HARQ codebook, the network entity (e.g., BS 102/180) may determine and/or identify, based on that set of HARQ processes included in the Type 3 HARQ codebook portion of the received modified multiplexed HARQ codebook 408, the one or more HARQ processes that were removed from the Type 2 HARQ codebook portion of the modified multiplexed HARQ codebook 408 received from the UE 104.

In some implementations, the UE 104 may modify the multiplexed HARQ codebook 406 by replacing the repetitive or duplicate HARQ processes in the Type 2 HARQ codebook portion of multiplexed HARQ codebook with a NACK or dummy bits. As described herein, dummy bits may be predetermined bits or bit values that indicate to the network entity (e.g., BS 102/180) that the corresponding HARQ process the codebook is a duplicate of another HARQ process transmitted as part of another type (e.g., Type 1, Type 2, Type 3, and the like) HARQ codebook.

In some implementations, the UE 104 may modify the multiplexed HARQ codebook by removing the repetitive or duplicated HARQ processes from the Type 3 HARQ codebook portion of the multiplexed HARQ codebook instead of the non-Type 3 HARQ codebook (e.g., Type 1 or Type 2 codebook) portion. For example, the UE 104 may remove the HARQ processes 5 and 7 from the Type 3 HARQ codebook portion 402 of the multiplexed HARQ codebook 406 instead of removing it from the Type 2 HARQ codebook portion 404 multiplexed HARQ codebook.

In some implementations, the UE 104 may modify the multiplexed HARQ codebook by replacing the repetitive or duplicate HARQ processes in the Type 3 HARQ codebook portion of the multiplexed HARQ codebook with a NACK or dummy bits. In some implementations, the UE 104 may transmit the repetitive HARQ processes in both the Type 3 HARQ codebook and a non-Type 3 (e.g., a Type 1 or a Type 2) HARQ codebook.

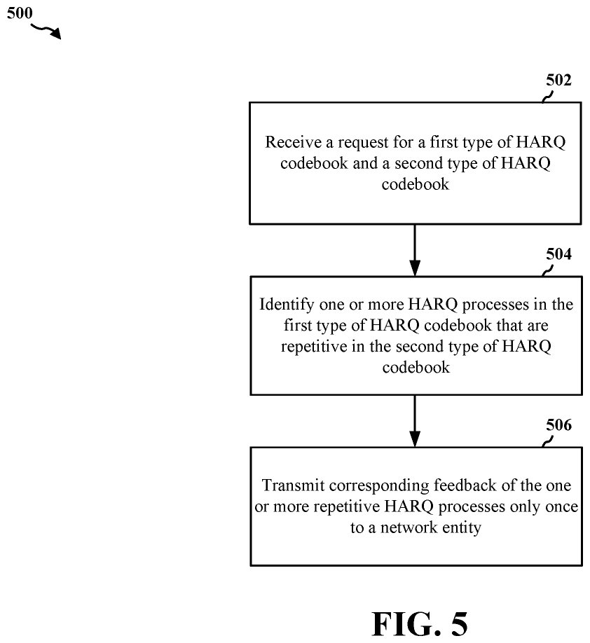

FIG. 5 is a flowchart of an example method 500 for a UE to transmit corresponding feedback of one or more repetitive HARQ processes only once. The method 500 may be performed by a UE (e.g., UE 104, which may include the memory 360 and which may be the entire UE 104 or a component of the UE 104, TX processor 368, the RX processor 356, or the controller/processor 359, UE 350, apparatus 702).

At block 502, the UE 104 may receive a request for a first type (e.g., a Type 3 HARQ codebook) of HARQ codebook and a second type (e.g., a Type 1 HARQ codebook, a Type 2 HARQ codebook, and the like). For example, the UE 104 may receive the request from the network entity (e.g., BS 102/180). For example, 502 may be performed by the HARQ request component 740. For In some implementations, as described above, the UE 104 may receive the request via DCI from the network entity (e.g., BS 102/180). In some implementations, the UE 104 may receive the receive the request for the first type and the second type HARQ codebook in the same slot. At block 504, the UE 104 may identify the one or more HARQ processes in the first type of HARQ codebook and that are repetitive in the second type of HARQ codebook. For example, 504 may be performed by the identifying component 748. The UE 104 may be configured to identify the one or more repetitive HARQ processes based on the set of HARQ process identifiers. For example, the UE 104 may be configured to identify that one or more HARQ processes are repeated in both the first type and the second type codebook by identifying their corresponding HARQ process identifiers in the first type and the second type HARQ codebook. At block 506, the UE 104 may be configured to transmit corresponding feedback of the one or more repetitive HARQ processes only once to a network entity. For example, 506 may be performed by the feedback component 750. In some implementations, the UE 104 may transmit the corresponding feedback of the one or more repetitive HARQ processes only once to the network entity by transmitting the first HARQ codebook (e.g., the Type 3 HARQ codebook) to the network entity, where the corresponding feedback of the one or more repetitive HARQ processes are indicated in the first type of HARQ codebook (e.g., Type 3 HARQ codebook). In some implementations, the UE 104 may transmit the corresponding feedback of the one or more repetitive HARQ processes only once to the network entity by refraining from transmitting the second type of HARQ codebook (e.g., Type 1 HARQ codebook or Type 2 HARQ codebook).

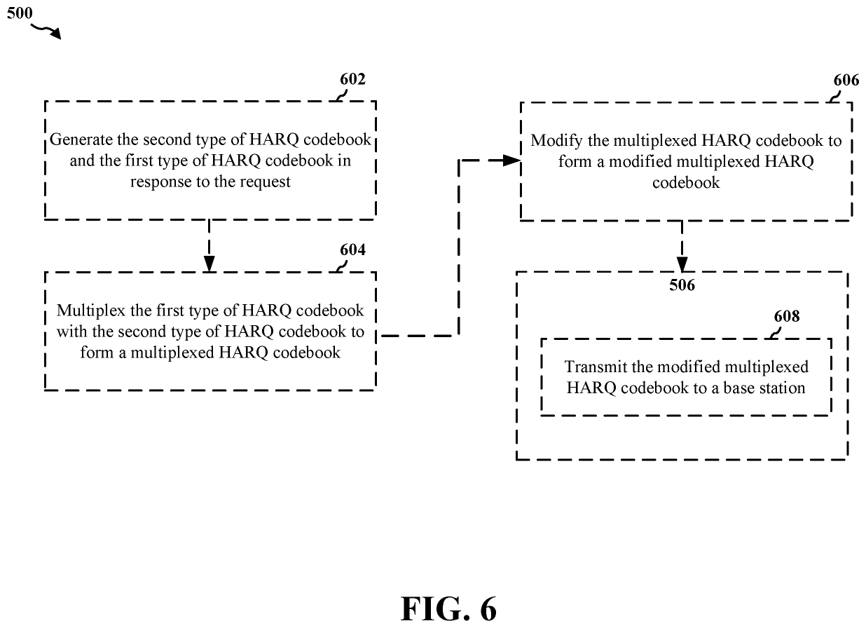

Referring to FIG. 6, in an alternative or additional aspect, at block 602, the method 500 may further include generating the second type of HARQ codebook (e.g., a Type 1 or a Type 2 HARQ codebook) and the first type of HARQ codebook in response to the request. For example, 602 may be performed by the generating component 742. In some implementations, the UE 104 may generate the second type of HARQ codebook before the first type of HARQ codebook. In this optional aspect, at block 604, the UE 104 may multiplex the first type of HARQ codebook with the second type of HARQ codebook to form a multiplexed HARQ codebook. For example, 604 may be performed by the multiplexing component 744. In this optional aspect, at block 606, the UE 104 may modify the multiplexed HARQ codebook to form a modified multiplexed HARQ codebook. For example, 606 may be performed by the modifying component 746. In this optional aspect, at block 608, the transmitting at block 506 may further include, transmitting the modified multiplexed HARQ codebook to a network entity (e.g., BS 102/180). For example, 608 may be performed by the feedback component 750.

In some implementations, the UE 104 may receive a message (e.g., via an RRC configuration) configuring the first type of HARQ codebook, wherein the message indicates a set of HARQ process identifiers (IDs) to include in the first type of HARQ codebook. In some implementations, the UE 104 may identify one or more repetitive HARQ process in the multiplexed HARQ codebook based on the set of HARQ process IDs.

In some implementation, the UE 104 may modify the multiplexed HARQ codebook by removing corresponding feedback in the multiplexed HARQ codebook of the one or more identified repetitive HARQ processes from a portion of the multiplexed HARQ codebook corresponding to the second type of HARQ codebook. In some implementations, where the second type of HARQ codebook is a Type 2 HARQ codebook, the UE 104 may update, based on the one or more removed HARQ processes, a counter downlink assignment index (DAI) and a total DAI associated with the second type of HARQ codebook. The UE 104 may transmit the updated counter DAI and the total DAI to the network entity (e.g., BS 102/180). In some implementations, a size of the modified multiplexed HARQ codebook is less than a size of the multiplexed HARQ codebook.

In some implementations, the UE 104 may modify the multiplexed HARQ codebook by replacing corresponding feedback in the multiplexed HARQ codebook of the one or more identified repetitive HARQ processes from a portion of the multiplexed HARQ codebook corresponding to the second type of HARQ codebook with a negative acknowledgement (NACK).

In some implementations, the UE 104 may modify the multiplexed HARQ codebook by replacing corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity (e.g., BS 102/180) that corresponding HARQ process is repetitive HARQ process and a feedback for which is provided in another portion of the transmitted HARQ codebook

In some implementations, the first type of HARQ codebook is a Type 3 HARQ codebook. In some implementation, the UE 104 may modify the multiplexed HARQ codebook by removing corresponding feedback in the multiplexed HARQ codebook of the one or more identified repetitive HARQ processes from a portion of the multiplexed HARQ codebook corresponding to the first type of HARQ codebook. In some implementation, the UE 104 may modify the multiplexed HARQ codebook by replacing corresponding feedback in the multiplexed HARQ codebook of the one or more identified repetitive HARQ processes from a portion of the multiplexed HARQ codebook corresponding to the first type of HARQ codebook with a negative acknowledgement (NACK).

In some implementation, the UE 104 may modify the multiplexed HARQ codebook by replacing corresponding feedback in the multiplexed HARQ codebook of the one or more identified repetitive HARQ processes from a portion of the multiplexed HARQ codebook corresponding to the first type of HARQ codebook with a set of bits predetermined to indicate to the network entity (e.g., BS 102/180) that corresponding HARQ process is repetitive HARQ process and a feedback for which is provided in another portion of the transmitted HARQ codebook.

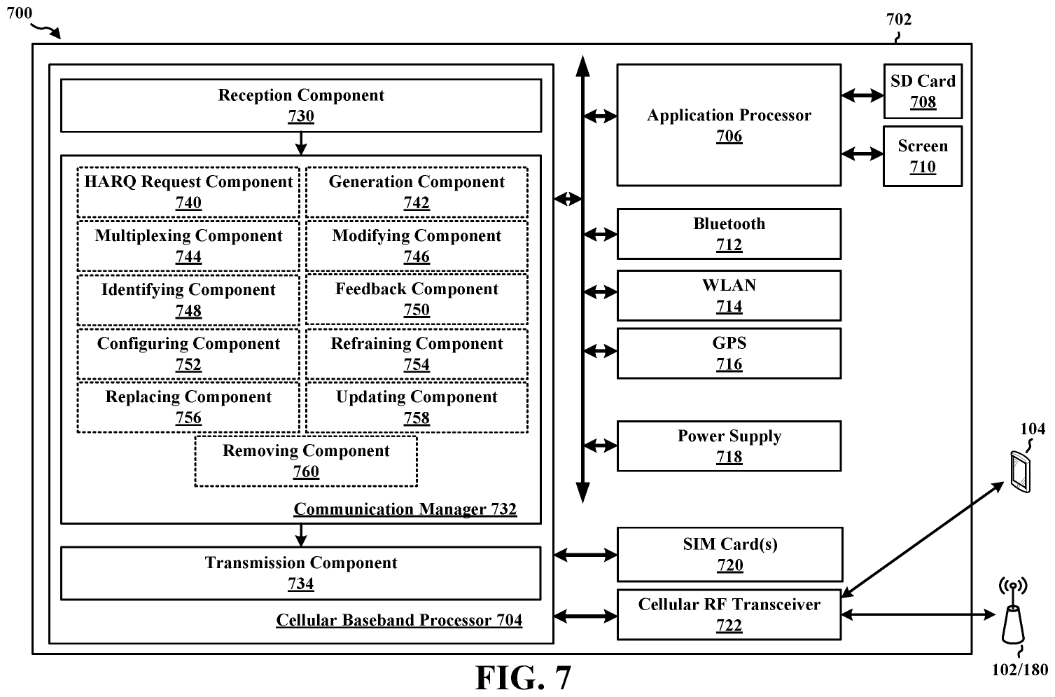

FIG. 7 is a diagram 700 illustrating an example of a hardware implementation for an apparatus 702. The apparatus 702 is a UE and includes a cellular baseband processor 704 (also referred to as a modem) coupled to a cellular RF transceiver 722 and one or more subscriber identity modules (SIM) cards 720, an application processor 706 coupled to a secure digital (SD) card 708 and a screen 710, a Bluetooth module 712, a wireless local area network (WLAN) module 714, a Global Positioning System (GPS) module 716, and a power supply 718. The cellular baseband processor 704 communicates through the cellular RF transceiver 722 with the UE 104 and/or BS 102/180. The cellular baseband processor 704 may include a computer-readable medium/memory. The computer-readable medium/memory may be non-transitory. The cellular baseband processor 704 is responsible for general processing, including the execution of software stored on the computer-readable medium/memory. The software, when executed by the cellular baseband processor 704, causes the cellular baseband processor 704 to perform the various functions described supra. The computer-readable medium/memory may also be used for storing data that is manipulated by the cellular baseband processor 704 when executing software. The cellular baseband processor 704 further includes a reception component 730, a communication manager 732, and a transmission component 734. The communication manager 732 includes the one or more illustrated components. The components within the communication manager 732 may be stored in the computer-readable medium/memory and/or configured as hardware within the cellular baseband processor 704. The cellular baseband processor 704 may be a component of the UE 350 and may include the memory 360 and/or at least one of the TX processor 368, the RX processor 356, and the controller/processor 359. In one configuration, the apparatus 702 may be a modem chip and include just the baseband processor 704, and in another configuration, the apparatus 702 may be the entire UE (e.g., see 350 of FIG. 3) and include the aforediscussed additional modules of the apparatus 702.

The communication manager 732 includes a HARQ request component 740 that is configured to receive request for a first type of HARQ codebook and a second type of HARQ codebook, e.g., as described in connection with block 502. The communications manager 732 further includes an identifying component 748 that is configured to identify one or more HARQ processes in the first type of HARQ codebook that are repetitive in the second type of HARQ codebook. The identifying component 748 may be further configured to identify the one or more repetitive HARQ process in the multiplexed HARQ codebook based on the set of HARQ process IDs.

The communication manager 732 further includes a feedback component 750 that is configured to transmit corresponding feedback of the one or more repetitive HARQ processes only once to a network entity, e.g., as described in connection with block 506. The feedback component 750 may be configured to transmit the first type of HARQ codebook (e.g., Type 3 HARQ codebook, or a Type 1 HARQ codebook, or a Type 2 HARQ codebook, etc.) to the network entity, where the corresponding feedback of the one or more repetitive HARQ processes are indicated in the first type of HARQ codebook. The feedback component 750 may be further configured to transmit the modified multiplexed HARQ codebook to the network entity, where the corresponding feedback of the one or more repetitive HARQ processes are indicated only once in the multiplexed HARQ codebook, e.g., as described in connection with block 608. The feedback component 750 may be further configured to transmit the updated counter DAI and the total DAI to the network entity.

The communication manager 732 further includes a generation component 752 that is configured to generate a first type of HARQ codebook and a second type of HARQ codebook, e.g., as described in connection with block 602. The communication manager 732 further includes a multiplexing component 744 that is configured to multiplex one HARQ codebook with another HARQ codebook, e.g., as described in connection with block 604. The communication manager 732 further includes a modifying component 746 that is configured to modify the multiplexed codebook, e.g., as described in connection with block 606.

The communication manager 732 may further include a refraining component 754 that is configured to refrain from transmitting the second type of HARQ codebook (e.g., Type 1 HARQ codebook, or Type 2 HARQ codebook, or Type 3 HARQ codebook, etc.). The communication manager 732 may further include a configuring component 752 that is configured to receive a message configuring the first type of HARQ codebook, wherein the message indicates a set of HARQ process identifiers (IDs) to include in the first type of HARQ codebook, wherein the set of HARQ process IDs include corresponding HARQ process IDs of the one or more repetitive HARQ processes.

The communication manager 732 may further include a removing component 760 that is configured to remove corresponding feedback in the multiplexed HARQ codebook of the one or more identified repetitive HARQ processes from a portion of the multiplexed HARQ codebook corresponding to the second type of HARQ codebook. The removing component 760 may be further configured to remove corresponding feedback in the multiplexed HARQ codebook of the one or more identified repetitive HARQ processes from a portion of the multiplexed HARQ codebook corresponding to the first type of HARQ codebook.

The communication manager 732 may further include an updating component 758 that is configured to update, based on the one or more removed HARQ processes, a counter downlink assignment index (DAI) and a total DAI associated with the second type of HARQ codebook. The communications manager 732 may further include a replacing component 756 that is configured to replace corresponding feedback in the multiplexed HARQ codebook of the one or more identified repetitive HARQ processes from a portion of the multiplexed HARQ codebook corresponding to the second type of HARQ codebook with a negative acknowledgement (NACK). The replacing component 756 may be further configured to replace corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity that corresponding HARQ process is repetitive HARQ process and a feedback for which is provided in another portion of the transmitted HARQ codebook. The replacing component 756 may be further configured to replace corresponding feedback in the multiplexed HARQ codebook of the one or more identified repetitive HARQ processes from a portion of the multiplexed HARQ codebook corresponding to the first type of HARQ codebook with a negative acknowledgement (NACK). The replacing component 756 may be further configured to replace corresponding feedback in the multiplexed HARQ codebook of the one or more identified repetitive HARQ processes from a portion of the multiplexed HARQ codebook corresponding to the first type of HARQ codebook with a set of bits predetermined to indicate to the network entity that corresponding HARQ process is repetitive HARQ process and a feedback for which is provided in another portion of the transmitted HARQ codebook.

The apparatus may include additional components that perform each of the blocks of the algorithm in the aforementioned flowcharts of FIGS. 5 and/or 6. As such, each block in the aforementioned flowcharts of FIGS. 5 and/or 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 702, and in particular the cellular baseband processor 704, includes means for receiving a request for a first type of HARQ codebook and a second type of HARQ codebook; means for identifying one or more HARQ processes in the first type of HARQ codebook that are repetitive in the second type of HARQ codebook; and means for transmitting corresponding feedback of the one or more repetitive HARQ processes only once to a network entity.

In one configuration, the apparatus 702, and in particular the cellular baseband processor 704, includes means for transmitting the first type of HARQ codebook to the network entity, wherein the corresponding feedback of the one or more repetitive HARQ processes are indicated in the first type of HARQ codebook.

In one configuration, the apparatus 702, and in particular the cellular baseband processor 704, includes means for refraining from transmitting the second type of HARQ codebook.

In one configuration, the apparatus 702, and in particular the cellular baseband processor 704, includes means for receiving a message configuring the first type of HARQ codebook, where the message indicates a set of HARQ process identifiers (IDs) to include in the first type of HARQ codebook, and where the set of HARQ process IDs include corresponding HARQ process IDs of the one or more repetitive HARQ processes.

In one configuration, the apparatus 702, and in particular the cellular baseband processor 704, includes means for generating the second type of HARQ codebook and the first type of HARQ codebook in response to the request, means for multiplexing the first type of HARQ codebook with the second type of HARQ codebook to form a multiplexed HARQ codebook, means for modifying the multiplexed HARQ codebook to form a modified multiplexed HARQ codebook, means for transmitting the modified multiplexed HARQ codebook to a network entity (e.g., BS 102/180), where the corresponding feedback of the one or more repetitive HARQ processes are indicated only once in the multiplexed HARQ codebook.

In one configuration, the apparatus 702, and in particular the cellular baseband processor 704, includes means for receiving a message configuring the first type of HARQ codebook, wherein the message indicates a set of HARQ process identifiers (IDs) to include in the first type of HARQ codebook. In one configuration, the apparatus 702, and in particular the cellular baseband processor 704, includes means for identifying, based on the set of HARQ process IDs, one or more repetitive HARQ process in the multiplexed HARQ codebook. In one configuration, the apparatus 702, and in particular the cellular baseband processor 704, includes means for removing corresponding feedback in the multiplexed HARQ codebook of the one or more identified repetitive HARQ processes from a portion of the multiplexed HARQ codebook corresponding to the second type of HARQ codebook.

In one configuration, the apparatus 702, and in particular the cellular baseband processor 704, includes means for updating, based on the one or more removed HARQ processes, a counter downlink assignment index (DAI) and a total DAI associated with the second type of HARQ codebook; and means for transmitting the updated counter DAI and the total DAI to the network entity (e.g., BS 102/180).

In one configuration, the apparatus 702, and in particular the cellular baseband processor 704, includes means for replacing corresponding feedback in the multiplexed HARQ codebook of the one or more identified repetitive HARQ processes from a portion of the multiplexed HARQ codebook corresponding to the second type of HARQ codebook with a negative acknowledgement (NACK).

In one configuration, the apparatus 702, and in particular the cellular baseband processor 704, includes means for replacing corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity (e.g., BS 102/180) that corresponding HARQ process is repetitive HARQ process and a feedback for which is provided in another portion of the transmitted HARQ codebook.

In one configuration, the apparatus 702, and in particular the cellular baseband processor 704, includes means for removing corresponding feedback in the multiplexed HARQ codebook of the one or more identified repetitive HARQ processes from a portion of the multiplexed HARQ codebook corresponding to the first type of HARQ codebook. In one configuration, the apparatus 702, and in particular the cellular baseband processor 704, includes means for replacing corresponding feedback in the multiplexed HARQ codebook of the one or more identified repetitive HARQ processes from a portion of the multiplexed HARQ codebook corresponding to the first type of HARQ codebook with a negative acknowledgement (NACK). In one configuration, the apparatus 702, and in particular the cellular baseband processor 704, includes means for replacing corresponding feedback in the multiplexed HARQ codebook of the one or more identified repetitive HARQ processes from a portion of the multiplexed HARQ codebook corresponding to the first type of HARQ codebook with a set of bits predetermined to indicate to the network entity (e.g., BS 102/180) that corresponding HARQ process is repetitive HARQ process and a feedback for which is provided in another portion of the transmitted HARQ codebook.

The aforementioned means may be one or more of the aforementioned components of the apparatus 702 configured to perform the functions recited by the aforementioned means. As described supra, the apparatus 702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.
1. A method of wireless communication, comprising:
   receiving a request for a first type of hybrid automatic repeat request (HARQ) codebook and a second type of HARQ codebook;
   identifying one or more HARQ processes in the first type of HARQ codebook that are repetitive in the second type of HARQ codebook; and
   transmitting corresponding feedback of the one or more repetitive HARQ processes only once to a network entity.
2. The method of clause 1, wherein transmitting the corresponding feedback of the one or more repetitive HARQ processes only once, further comprises:
   transmitting the first codebook to the network entity, wherein the corresponding feedback of the one or more repetitive HARQ processes are indicated in the first type of HARQ codebook.
3. The method of any of the preceding clauses, further comprising:
   refraining from transmitting the second type of HARQ codebook.
4. The method of any of the preceding clauses, further comprising:
   receiving a message configuring the first type of HARQ codebook, wherein the message indicates a set of HARQ process identifiers (IDs) to include in the first type of HARQ codebook, wherein the set of HARQ process IDs include corresponding HARQ process IDs of the one or more repetitive HARQ processes.
5. The method of any of the preceding clauses, further comprising:
   generating the second type of HARQ codebook and the first type of HARQ codebook in response to the request;
   multiplexing the first type of the HARQ codebook with the second type of HARQ codebook to form a multiplexed HARQ codebook;
   modifying the multiplexed HARQ codebook to form a modified multiplexed HARQ codebook; and
   wherein transmitting the corresponding feedback of the one or more repetitive HARQ processes only once to the network entity further comprises transmitting the modified multiplexed HARQ codebook to the network entity, wherein the corresponding feedback of the one or more repetitive HARQ processes are indicated only once in the multiplexed HARQ codebook.
6. The method of any of the preceding clauses, wherein modifying the multiplexed HARQ codebook further comprises:
   identifying, based on the set of HARQ process IDs, one or more repetitive HARQ process in the multiplexed HARQ codebook.
7. The method of any of the preceding clauses, further comprising
   removing corresponding feedback in the multiplexed HARQ codebook of the one or more identified repetitive HARQ processes from a portion of the multiplexed HARQ codebook corresponding to the second type of HARQ codebook.
8. The method of any of the preceding clauses, wherein the second type of HARQ codebook is a Type 2 HARQ codebook, and the method further comprises:
   updating, based on the one or more removed HARQ processes, a counter downlink assignment index (DAI) and a total DAI associated with the second type of HARQ codebook; and
   transmitting the updated counter DAI and the total DAI to the network entity.
9. The method of any of the preceding clauses, wherein a size of the modified multiplexed HARQ codebook is less than a size of the multiplexed HARQ codebook.
10. The method of any of the preceding clauses, further comprising:
   replacing corresponding feedback in the multiplexed HARQ codebook of the one or more identified repetitive HARQ processes from a portion of the multiplexed HARQ codebook corresponding to the second type of HARQ codebook with a negative acknowledgement (NACK).
11. The method of any of the preceding clauses, further comprising:
   replacing corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity that corresponding HARQ process is repetitive HARQ process and a feedback for which is provided in another portion of the transmitted HARQ codebook.
12. The method of any of the preceding clauses, wherein the first type of HARQ codebook is a Type 3 HARQ codebook.
13. The method of any of the preceding clauses, further comprising:
   removing corresponding feedback in the multiplexed HARQ codebook of the one or more identified repetitive HARQ processes from a portion of the multiplexed HARQ codebook corresponding to the first type of HARQ codebook.
14. The method of any of the preceding clauses, further comprising:
   replacing corresponding feedback in the multiplexed HARQ codebook of the one or more identified repetitive HARQ processes from a portion of the multiplexed HARQ codebook corresponding to the first type of HARQ codebook with a negative acknowledgement (NACK).
15. The method of any of the preceding clauses, further comprising:
   replacing corresponding feedback in the multiplexed HARQ codebook of the one or more identified repetitive HARQ processes from a portion of the multiplexed HARQ codebook corresponding to the first type of HARQ codebook with a set of bits predetermined to indicate to the network entity that corresponding HARQ process is repetitive HARQ process and a feedback for which is provided in another portion of the transmitted HARQ codebook.
16. An apparatus for wireless communication, comprising:
   a memory; and
   a processor communicatively coupled with the memory and configured to:
      receive a request for a first type of hybrid automatic repeat request (HARQ) codebook and a second type of HARQ codebook;
      identify one or more HARQ processes in the first type of HARQ codebook that are repetitive in the second type of HARQ codebook; and
      transmit corresponding feedback of the one or more repetitive HARQ processes only once to a network entity.
17. The apparatus of clause 16, wherein the processor configured to transmit the corresponding feedback of the one or more repetitive HARQ processes only once, the processor is further configured to:
   transmit the first codebook to the network entity, wherein the corresponding feedback of the one or more repetitive HARQ processes are indicated in the first type of HARQ codebook.
18. The apparatus of any of the preceding clauses, wherein the processor is further configured to:
   refrain from transmitting the second type of HARQ codebook.
19. The apparatus of any of the preceding clauses, wherein the processor is further configured to:
   receive a message configuring the first type of HARQ codebook, wherein the message indicates a set of HARQ process identifiers (IDs) to include in the first type of HARQ codebook, wherein the set of HARQ process IDs include corresponding HARQ process IDs of the one or more repetitive HARQ processes.
20. The apparatus of any of the preceding clauses, wherein the processor is further configured to:
   generate the second type of HARQ codebook and the first type of HARQ codebook in response to the request;
   multiplex the first type of the HARQ codebook with the second type of HARQ codebook to form a multiplexed HARQ codebook;
   modify the multiplexed HARQ codebook to form a modified multiplexed HARQ codebook; and
   wherein to transmit the corresponding feedback of the one or more repetitive HARQ processes only once to the network entity, the processor is further configured to transmit the modified multiplexed HARQ codebook to the network entity, wherein the corresponding feedback of the one or more repetitive HARQ processes are indicated only once in the multiplexed HARQ codebook.
21. The apparatus of any of the preceding clauses, wherein to modify the multiplexed HARQ codebook the processor is further configured to:
   identify, based on the set of HARQ process IDs, one or more repetitive HARQ process in the multiplexed HARQ codebook.
22. The apparatus of any of the preceding clauses, wherein the processor is further configured to:
   remove corresponding feedback in the multiplexed HARQ codebook of the one or more identified repetitive HARQ processes from a portion of the multiplexed HARQ codebook corresponding to the second type of HARQ codebook.
23. The apparatus of any of the preceding clauses, wherein the second type of HARQ codebook is a Type 2 HARQ codebook, and the processor is further configured to:
   update, based on the one or more removed HARQ processes, a counter downlink assignment index (DAI) and a total DAI associated with the second type of HARQ codebook; and
   transmit the updated counter DAI and the total DAI to the network entity.
24. The apparatus of any of the preceding clauses, wherein a size of the modified multiplexed HARQ codebook is less than a size of the multiplexed HARQ codebook.
25. The apparatus of any of the preceding clauses, wherein the processor is further configured to:
   replace corresponding feedback in the multiplexed HARQ codebook of the one or more identified repetitive HARQ processes from a portion of the multiplexed HARQ codebook corresponding to the second type of HARQ codebook with a negative acknowledgement (NACK).
26. The apparatus of any of the preceding clauses, wherein the processor is further configured to:
   replace corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity that corresponding HARQ process is repetitive HARQ process and a feedback for which is provided in another portion of the transmitted HARQ codebook.
27. The apparatus of any of the preceding clauses, wherein the first type of HARQ codebook is a Type 3 HARQ codebook.
28. The apparatus of any of the preceding clauses, wherein the processor is further configured to:
   remove corresponding feedback in the multiplexed HARQ codebook of the one or more identified repetitive HARQ processes from a portion of the multiplexed HARQ codebook corresponding to the first type of HARQ codebook.
29. The apparatus of any of the preceding clauses, wherein the processor is further configured to:
   replace correspond feedback in the multiplexed HARQ codebook of the one or more identified repetitive HARQ processes from a portion of the multiplexed
   HARQ codebook corresponding to the first type of HARQ codebook with a negative acknowledgement (NACK).
30. The apparatus of any of the preceding clauses, wherein the processor is further configured to:
   replace correspond feedback in the multiplexed HARQ codebook of the one or more identified repetitive HARQ processes from a portion of the multiplexed HARQ codebook corresponding to the first type of HARQ codebook with a set of bits predetermined to indicate to the network entity that corresponding HARQ process is repetitive HARQ process and a feedback for which is provided in another portion of the transmitted HARQ codebook.
31. An apparatus for wireless communication, comprising one or more means for performing the method of clauses 1-15.
32. A computer-readable medium comprising stored instructions for wireless communication, executable by a processor to perform the method of any of the clauses 1-15.
   The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication, comprising:
receiving a request for a first type of hybrid automatic repeat request (HARQ) codebook and a second type of HARQ codebook;
identifying one or more HARQ processes in the first type of HARQ codebook that are repetitive in the second type of HARQ codebook; and
transmitting corresponding feedback of the one or more repetitive HARQ processes only once to a network entity.

2. The method of claim 1, wherein transmitting the corresponding feedback of the one or more repetitive HARQ processes only once, further comprises:
transmitting the first type of HARQ codebook to the network entity, wherein the corresponding feedback of the one or more repetitive HARQ processes are indicated in the first type of HARQ codebook.

3. The method of claim 2, further comprising:
refraining from transmitting the second type of HARQ codebook.

4. The method of claim 1, further comprising:
receiving a message configuring the first type of HARQ codebook, wherein the message indicates a set of HARQ process identifiers (IDs) to include in the first type of HARQ codebook, wherein the set of HARQ process IDs include corresponding HARQ process IDs of the one or more repetitive HARQ processes.

5. The method of claim 4, further comprising:
generating the second type of HARQ codebook and the first type of HARQ codebook in response to the request;
multiplexing the first type of the HARQ codebook with the second type of HARQ codebook to form a multiplexed HARQ codebook;
modifying the multiplexed HARQ codebook to form a modified multiplexed HARQ codebook; and
wherein transmitting the corresponding feedback of the one or more repetitive HARQ processes only once to the network entity further comprises transmitting the modified multiplexed HARQ codebook to the network entity, wherein the corresponding feedback of the one or more repetitive HARQ processes are indicated only once in the multiplexed HARQ codebook.

6. The method of claim 5, wherein modifying the multiplexed HARQ codebook further comprises:
identifying, based on the set of HARQ process IDs, one or more repetitive HARQ process in the multiplexed HARQ codebook.

7. The method of claim 6, further comprising:
removing corresponding feedback in the multiplexed HARQ codebook of the one or more identified repetitive HARQ processes from a portion of the multiplexed HARQ codebook corresponding to the second type of HARQ codebook.

8. The method of claim 7, wherein the second type of HARQ codebook is a Type 2 HARQ codebook, and the method further comprises:
updating, based on the one or more removed HARQ processes, a counter downlink assignment index (DAI) and a total DAI associated with the second type of HARQ codebook; and
transmitting the updated counter DAI and the total DAI to the network entity.

9. The method of claim 7, wherein a size of the modified multiplexed HARQ codebook is less than a size of the multiplexed HARQ codebook.

10. The method of claim 6, further comprising:
replacing corresponding feedback in the multiplexed HARQ codebook of the one or more identified repetitive HARQ processes from a portion of the multiplexed HARQ codebook corresponding to the second type of HARQ codebook with a negative acknowledgement (NACK).

11. The method of claim 6, further comprising:
replacing corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity that corresponding HARQ process is repetitive HARQ process and a feedback for which is provided in another portion of the transmitted HARQ codebook.

12. The method of claim 1, wherein the first type of HARQ codebook is a Type 3 HARQ codebook.

13. The method of claim 12, further comprising:
removing corresponding feedback in the multiplexed HARQ codebook of the one or more identified repetitive HARQ processes from a portion of the multiplexed HARQ codebook corresponding to the first type of HARQ codebook.

14. The method of claim 12, further comprising:
replacing corresponding feedback in the multiplexed HARQ codebook of the one or more identified repetitive HARQ processes from a portion of the multiplexed HARQ codebook corresponding to the first type of HARQ codebook with a negative acknowledgement (NACK).

15. The method of claim 12, further comprising:
replacing corresponding feedback in the multiplexed HARQ codebook of the one or more identified repetitive HARQ processes from a portion of the multiplexed HARQ codebook corresponding to the first type of HARQ codebook with a set of bits predetermined to indicate to the network entity that corresponding HARQ process is repetitive HARQ process and a feedback for which is provided in another portion of the transmitted HARQ codebook.

16. An apparatus for wireless communication, comprising:
a memory; and
a processor communicatively coupled with the memory and configured to:
receive a request for a first type of hybrid automatic repeat request (HARQ) codebook and a second type of HARQ codebook;
identify one or more HARQ processes in the first type of HARQ codebook that are repetitive in the second type of HARQ codebook; and
transmit corresponding feedback of the one or more repetitive HARQ processes only once to a network entity.

17. The apparatus of claim 16, wherein the processor configured to transmit the corresponding feedback of the one or more repetitive HARQ processes only once, the processor is further configured to:
transmit the first codebook to the network entity, wherein the corresponding feedback of the one or more repetitive HARQ processes are indicated in the first type of HARQ codebook.

18. The apparatus of claim 17, wherein the processor is further configured to:
refrain from transmitting the second type of HARQ codebook.

19. The apparatus of claim 16, wherein the processor is further configured to:
receive a message configuring the first type of HARQ codebook, wherein the message indicates a set of HARQ process identifiers (IDs) to include in the first type of HARQ codebook, wherein the set of HARQ process IDs include corresponding HARQ process IDs of the one or more repetitive HARQ processes.

20. The apparatus of claim 19, wherein the processor is further configured to:
generate the second type of HARQ codebook and the first type of HARQ codebook in response to the request;
multiplex the first type of the HARQ codebook with the second type of HARQ codebook to form a multiplexed HARQ codebook;
modify the multiplexed HARQ codebook to form a modified multiplexed HARQ codebook; and
wherein to transmit the corresponding feedback of the one or more repetitive HARQ processes only once to the network entity, the processor is further configured to transmit the modified multiplexed HARQ codebook to the network entity, wherein the corresponding feedback of the one or more repetitive HARQ processes are indicated only once in the multiplexed HARQ codebook.

21. The apparatus of claim 20, wherein the processor configured to modify the multiplexed HARQ codebook, the processor is further configured to:
identify, based on the set of HARQ process IDs, the one or more repetitive HARQ processes in the multiplexed HARQ codebook.

22. The apparatus of claim 21, wherein the processor is further configured to:
remove corresponding feedback in the multiplexed HARQ codebook of the one or more identified repetitive HARQ processes from a portion of the multiplexed HARQ codebook corresponding to the second type of HARQ codebook.

23. The apparatus of claim 22, wherein the second type of HARQ codebook is a Type 2 HARQ codebook, and the processor is further configured to:
update, based on the one or more removed HARQ processes, a counter downlink assignment index (DAI) and a total DAI associated with the second type of HARQ codebook; and
transmit the updated counter DAI and the total DAI to the network entity.

24. The apparatus of claim 22, wherein a size of the modified multiplexed HARQ codebook is less than a size of the multiplexed HARQ codebook.

25. The apparatus of claim 21, wherein the processor is further configured to:
replace corresponding feedback in the multiplexed HARQ codebook of the one or more identified repetitive HARQ processes from a portion of the multiplexed HARQ codebook corresponding to the second type of HARQ codebook with a negative acknowledgement (NACK).

26. The apparatus of claim 21, wherein the processor is further configured to:
replace corresponding feedback in the multiplexed HARQ codebook of the one or more identified repetitive HARQ processes from a portion of the multiplexed HARQ codebook corresponding to the second type of HARQ codebook with a set of bits predetermined to indicate to the network entity that corresponding HARQ process is repetitive HARQ process and a feedback for which is provided in another portion of the transmitted HARQ codebook.

27. The apparatus of claim 16, wherein the first type of HARQ codebook is a Type 3 HARQ codebook.

28. The apparatus of claim 27, wherein the processor is further configured to:
remove corresponding feedback in the multiplexed HARQ codebook of the one or more identified repetitive HARQ processes from a portion of the multiplexed HARQ codebook corresponding to the first type of HARQ codebook.

29. The apparatus of claim 27, wherein the processor is further configured to:
replace correspond feedback in the multiplexed HARQ codebook of the one or more identified repetitive HARQ processes from a portion of the multiplexed HARQ codebook corresponding to the first type of HARQ codebook with a negative acknowledgement (NACK).

30. The apparatus of claim 27, wherein the processor is further configured to:
replace correspond feedback in the multiplexed HARQ codebook of the one or more identified repetitive HARQ processes from a portion of the multiplexed HARQ codebook corresponding to the first type of HARQ codebook with a set of bits predetermined to indicate to the network entity that corresponding HARQ process is repetitive HARQ process and a feedback for which is provided in another portion of the transmitted HARQ codebook.
